(19) United States
(12) Patent Application Publication
(10) Pub. No.: US 2008/0190464 A1
(43) Pub. Date: Aug. 14, 2008

(54) Sieve Element For A Dishwasher

(75) Inventors: Rolf Stahlmann, Wolframs-Eschenbach (DE); Winfried Steiner, Nurnberg (DE); Klaus Martin Forst, Zirndorf (DE); Stefan Fuglein, Nurnberg (DE); Friedrich Mack, Nurnberg (DE)

Correspondence Address: PEARNE & GORDON LLP, 1801 EAST 9TH STREET, SUITE 1200, CLEVELAND, OH, 44114-3108, US

(73) Assignee: ELECTROLUX HOME PRODUCTS CORPORATION N.V., Zaventem (BE)

(21) Appl. No.: 11/910,647

(22) PCT Filed: Mar. 25, 2006
(86) PCT No.: PCT/EP2006/002748

§ 371 Date: Feb. 18, 2008

(30) Foreign Application Priority Data
Apr. 5, 2005 (EP) 05007343.6

(51) Int. Cl. B08B 3/02

(52) U.S. Cl. 134/110

(57) ABSTRACT

The invention concerns a sieve device for a dishwasher with a sieve surface (2) and a plurality of holes made in the sieve surface. According to the invention, the holes in the sieve surface are designed to be different sizes.

The invention concerns a sieve device for a dishwasher that is placed in the floor of the dishwasher and keeps rough impurities out of the suction area of the circulating pump.

Conventional flat sieves for dishwashers have sieve holes all with the same diameter. If the dishes put into the dishwasher have an impurity made up of a plurality of particles the same size, they can cover large areas of the sieve holes if the size of the impurity residues is approximately in the range of the hole size. This is the case, for example, with coffee grounds, in which the ground coffee particles are not broken down any further during the washing, but have a particle size in the range of the diameter of the sieve hole, depending on how finely they are ground. If the surface of the sieve is covered with these kinds of particles, it can affect the washing results or operation.

The problem of the invention is to design a sieve device for a dishwasher on a dishwasher so that the sieve function is not affected if there is a plurality of small particles of impurities the same size.

The problem is solved with the features in Claim 1 and 15.

Advantageous embodiments are the subject of the subclaims.

According to Claim 1, a sieve device is provided with a large number of sieve holes distributed over the surface of the sieve. The holes are not uniform in size, but are different sizes. For example, the hole size is statistically distributed around a mean hole size, with the hole size deviating above and below. Or there are two or more groups of hole sizes, and the holes in each group are uniform in size.

Using different hole sizes, when the sieve device is in a wash cycle, in which there is a plurality of particles of impurities that are uniform or almost uniform in size prevents the particles from uniformly blocking all of the holes on the surface of the sieve. For example, small particles will cover only the smaller size sieve holes, but will be rinsed through the larger sieve holes. This prevents complete coverage of the sieve device. Or if the particles are larger, only the large sieve holes will be covered by the particles, while the particles that are too big will not fit through the smaller sieve holes, so they will be washed away from the entrance to the smaller sieve holes during the wash cycle.

It is a great advantage for the sieve device to have a surface sieve placed as a filter device in front of the suction hole of the circulating pump of a dishwasher. The advantage is the size (diameter or minimum cross section) from the smallest to the largest hole, in the range of 0.4 mm to 2 mm, and a special advantage in the range from 0.6 mm to 1.2 mm, so that, on one hand, particles up to a certain size can take part in the circulating process, while particles that are too large are kept away from the circulating process during a rinse cycle, for example by collecting the larger particles in a rough/fine sieve.

In one highly advantageous embodiment, the surface of the sieve itself is structured, i.e., compared to a basic sieve surface or plane, there are sieve surfaces that project up or go down.

The basic sieve surface here means the surface that the sieve would take up if there were no structuring. The sieve surface itself can be shaped as a whole, for example, as a funnel-shaped surface, cone-shaped surface, conical surface or the like. Projections and depressions mean a projection or depression compared to that surface. Naturally, there is a certain freedom in the ‘determination’ of the basic sieve surface, whereby, for example, the deepest points of recesses can be accepted as a basic surface or the highest points of the projections as the basic surface, and the structures formed into this fictive basic surface are then accepted as projections and/or depressions.

Structuring the sieve surface helps wash out clogged sieve holes in the higher sieve areas. Sieve holes in the raised areas are preferably larger than sieve holes in the plane of the basic surface. Larger particles of impurities thereby collect preferably in the deeper sieve surface areas and smaller impurities, which are torn apart more easily by the current, fall through the larger sieve holes in the raised areas, so that the sieve holes in the raised areas are predominantly kept free.

A special advantage is the ducts formed by the elevations and/or depressions within the sieve surface that run in the direction of the height gradients of the basic sieve surface. If there are particles of impurities that are too large to go through the sieve holes or if the smaller sieve holes are partly clogged, particles of impurities in the ducts are taken to deeper areas of the sieve surface. Advantageously, there is a hole there in which a rough/fine sieve with large holes is provided, for example, so that the particles of impurities transported in the ducts along the sieve surface go into the rough/fine sieve and are removed by the circulating circuit.

The fact that the cross section of the holes is not round, but polygonal (triangle, square, etc.) helps the wash liquid to drip or flow through the holes. Especially if plastic is used as the basic material of the sieve device or sieve surface, despite the higher adjacent surface tension, this promotes dripping from the plastic sieve into the catch basin under it.

In another embodiment of a sieve device, the sieve device itself is made of plastic or basically of plastic, and the sieve holes have a cross section with at least one edge, in order to take the moisture from the top of the sieve surface to the bottom by capillary action. Here, the holes must not have different sizes, but have only one different size, according to one advantageous embodiment.

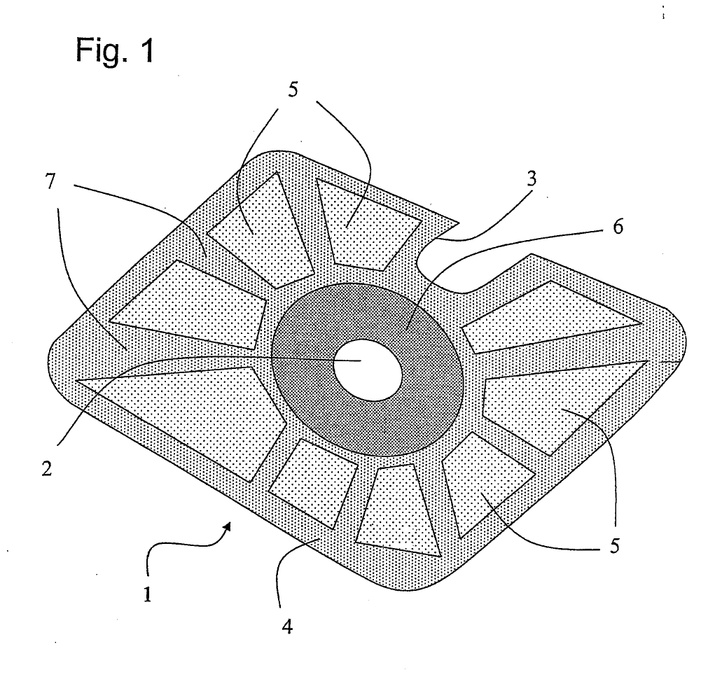

One form of embodiment of the invention will be explained using FIG. 1.

FIG. 1 shows a schematic, perspective view of a surface sieve 1, which can be used in the washing compartment of a dishwasher. In the center, there is a central hole 2, in which a rough/fine sieve can be installed in the conventional way. The rinse fluid collecting on the floor or machine sump goes through the holes of the surface sieve 1 into a space under it, from which a circulating pump sucks up the rinse fluid and distributes it via a spray arm onto the dishes to be washed inside the dishwasher. The wash liquid running through the central hole 2 in the rough/fine sieve either goes through the fine sieve of the rough/fine sieve and into the space under the surface sieve 1 or into the suction area of an emptying pump, which sucks the suctioned dishwashing liquid out of the dishwasher.

On the back of the surface sieve 1, there is an indentation 3, with which the surface sieve 1 can be pushed via a connecting support of a lower spray arm. The basic surface 4 of the surface sieve 1 is designed to be slightly funnel-shaped, whereby the central hole 2 represents the deepest point of the surface 4. Around the central hole 2 is a middle area 6 in the plane of the surface 4 (i.e., slightly funnel-shaped or conical running toward the central hole 2). Around the middle area 6 there are flat convex areas 5, which are curved out approximately 3 to 5 mm upward and offset to the basic surface 4. Between the convex areas 5 run grooves 7 in the plane of the basic surface 4, whereby the grooves 7 run radially in the direction of the central hole 2.

As indicated by the surface model in the various surface areas of the surface sieve 1, the diameters of the sieve holes in the different areas are different. In the middle area, the hole diameter is approximately 0.6 mm. In the area of the adjacent basic surface 4, the hole diameter is 0.75 mm. In the area of the convex places 5 and elevations, the hole diameter is 1 or 1.2 mm. The hole density, i.e., the number of holes per unit of surface, is the same in all three surface areas 4, 6, 5. One embodiment provides for the hole density to increase as the hole diameters become smaller.

### REFERENCE LIST

1 Surface sieve
2 Central hole
3 Indentation
4 Basic surface
5 Convex area
6 Middle area
7 Groove

1. A sieve device for a dishwasher with a sieve surface (2) and a plurality of holes formed in the sieve surface, characterized by the fact that the holes in the sieve surface are designed to be different sizes.

2. The sieve device in claim 1, where the sieve device is a surface sieve (1).

3. The sieve device in claim 1 or 2, where holes of a first size are made in one or more first subareas (4, 5, 6) of the sieve surface, and holes of a second size different from the first size are made in one or more second subareas (4, 5, 6) on the surface of the sieve.

4. The sieve device in one of the preceding claims, wherein the hole size in the subareas (4, 5) of the sieve surface with large holes goes over to the subareas of the sieve surface (4, 6) with small holes in stages or gradually.

5. The sieve device in one of the preceding claims, whereby the size of all holes in the area is from 0.4 to 2 mm, preferably in the range from 0.6 to 1.5 mm and very preferably in the range from 0.6 to 1.2 mm.

6. The sieve device in one of the preceding claims, whereby the difference between the smallest hole size and the largest hole size is larger than or equal to 0.2 mm, preferably larger than or equal to 0.4 mm.

7. The sieve device in one of the preceding claims, wherein the sieve surface is structured, wherein in the area of a first type of structure are arranged holes of one or basically one first size, and in the area of a second type of structure, especially the basic surface (4, 6) of the sieve, are arranged holes of one or basically a second size.

8. The sieve device in claim 7, whereby the sieve surface, as the structure, has elevations (5) and/or depressions relative to a sieve basic surface (4, 6), whereby the holes of the first size are arranged in the area of the elevations (5) and/or depressions, and the holes of the second size are arranged in the area of the basic surface of the sieve (4, 6).

9. The sieve device in claim 8 or 9, whereby in the area of the depressions, the hole size is smaller than in the area of the basic sieve surface (4, 6) and/or the depressions.

10. The sieve device in claim 8 or 9, whereby in the area of the depressions, the hole size is smaller than in the area of the basic sieve surface (4, 6) and or the elevations (5).

11. The sieve device in one of the preceding claims, whereby the sieve surface has a hole (2) for inserting a sieve element, an incline in the direction of the hole (2) and ducts (7) and/or depressions are made that run in the direction of the hole in the sieve surface, especially depressions according to one of claims 7 to 9.

12. The sieve device in one of claims 7 to 11, whereby the sieve surface (4, 6) is designed to be undulating all over or in one subarea with wave peaks and valleys running to a point.

13. The sieve device, especially in one of the preceding claims, whereby the sieve device (1) is made of plastic, especially of polypropylene (PP) or polyacetal (POM).

14. The sieve device in one of the preceding claims, whereby at least some of the holes are rectangular, trapezoidal and/or triangular.

15. A dishwasher with a sieve device (1) according to one of the preceding claims.
